(19) United States
(12) Patent Application Publication
(10) Pub. No.: US 2013/0082129 A1
(43) Pub. Date: Apr. 4, 2013

(54) TRANSPORTABLE ROLLER MILL AND TRANSPORTABLE GRINDING INSTALLATION

(71) Applicants: Matthias Authenrieth, Neuenstadt (DE); Christian Barczus, Witten (DE); Joerg Bettenworth, Alsdorf (DE); Nigel Hendy, Ratingen (DE); Wilhelm Kulagin, Duesseldorf (DE); Holger Wulfert, Berlin (DE)

(72) Inventors: Matthias Authenrieth, Neuenstadt (DE); Christian Barczus, Witten (DE); Joerg Bettenworth, Alsdorf (DE); Nigel Hendy, Ratingen (DE); Wilhelm Kulagin, Duesseldorf (DE); Holger Wulfert, Berlin (DE)

(73) Assignee: LOESCH GMBH, Duesseldorf (DE)

(21) Appl. No.: 13/639,717

(22) PCT Filed: Nov. 22, 2010
(86) PCT No.: PCT/EP10/07070

§ 371 Date: Dec. 17, 2012

(51) Int. Cl. B02C 15/00; B02C 19/18; B02C 23/08; B02C 21/02

(52) U.S. Cl. CPC B02C 15/00; B02C 15/006; B02C 21/02; B02C 19/186; B02C 23/08
USPC 241/65; 241/227; 241/231; 241/68; 241/285.1

(57) ABSTRACT

The invention relates to a transportable roller mill for reducing solids with a mill housing, a grinding pan, two grinding rollers, two swing lever units, a grinding pan drive and a gear for the grinding pan. It is further provided that the roller mil is arranged for transport and operation in a container. The swing lever units are respectively connected to the mill housing and supports extend from the connection regions of the swing lever units to the bottom of the container. Vibration dampers are provided between the container bottom and the supports. The invention further relates to a grinding installation.

The invention relates to a transportable roller mill for reducing solids, in particular solid fuels.

Roller mills of the generic type, e.g. DE 3134601 C2 or DE 4202784 C2, comprise a mill housing, a grinding pan, at least two grinding rollers, at least two swing lever units, a grinding pan drive, a gear unit for the grinding pan and a gear housing. These components of a mill are also described as a mill assembly. The at least two grinding rollers roll in a friction locking way with the grinding material on the grinding pan or on the grinding plate. The material to be reduced thereby forms a grinding material bed on the grinding pan. The grinding rollers as well as the grinding pan are arranged in the mill housing, whereby each grinding roller is assigned to a swing lever unit for bearing, force application onto the grinding material and pivoting out.

The invention further relates to a transportable grinding installation for reducing solids which comprises the inventive roller mill.

In the fields of the energy-intensive industry a trend can generally be ascertained whereby it is attempted to minimise or make more efficient the use of pure or high quality energy carriers. One possibility is to replace pure energy carriers such as crude oil or natural gas by other energy carriers such as coal for example. This is carried out having regard to costs saving as pure energy carriers have a higher purchase price than non-pure or lower quality energy carriers. Another aspect which is now already considered is that the worldwide crude oil supplies will be exhausted in around 50 years according to current forecasts. This would, on the one hand, lead to further price increases in this sector within the next 50 years. On the other hand the energy-intensive industries are now already starting to use other energy carriers.

Unlike pure energy carriers, coal for example must firstly be prepared on a larger scale. For this purpose there are for example three large brown coal preparation plants in Germany. Pre-dried brown coal or brown coal with low moisture content is dried and ground to dust in these preparation plants, whereby dust has better properties in combustion and thus offers a higher energy yield. These brown coal preparation plants are used for dust production.

The plants are thereby dimensioned so that they achieve a brown coal throughput of approximately 50 to 90 tonnes per hour. The further processing of the dust produced takes place in part on site. In particular at the three German brown coal dust preparation plants, however, a transport of the dust in special vehicles within a radius of 1000 km is also carried out. This dust is delivered there to consumers who use the dust for example within the scope of asphalt mixing plants for the production of road surfacing or for steam production for power generators.

The brown coal dust plants used in Germany have a height of approximately 70 m. A high throughput is indeed hereby achieved but it has not been possible here thus far to use the dust produced directly but instead it must—as mentioned—be distributed in special vehicles to further consumers. Insofar the purchaser of the dust wishes to produce it directly on site if possible in order to be able to save on the dust transport requiring great resources. It is, however, hereby to be considered that the consumers themselves only require smaller quantities of dust so that the installations used there must be dimensioned to be much smaller.

Besides the dust production in Germany, however, such a preparation of coal as an energy carrier is also of interest for other countries which are not as greatly industrialised, in particular emerging countries or developing countries. Most countries worldwide have coal to a certain degree which can be used as an energy carrier. Furthermore it is to be considered precisely with developing countries that the infrastructure available there is developed to a very limited extent so that the structure of large coal grinding plants and the operation thereof is associated with very high resources. Particularly the transport of the individual elements of the grinding plant and the maintaining of the operation are hereby to be classified as requiring great resources.

A further disadvantage with such coal grinding plants with large dimensions is that once they are constructed on site and operated they can essentially no longer be dismantled and newly installed at another location with justifiable resources. Such coal grinding plants normally have a preparation period from the definitive order confirmation until operation of at least 2 years.

It is an object of the invention to create a roller mill and a grinding installation for reducing solid fuels which is easy and effective to transport and install.

This object is achieved according to the invention through a roller mill having the features of claim 1 and a grinding installation having the features of claim 11.

Further advantageous embodiments are indicated in the dependent claims, the description and the figures.

It is provided according to claim 1 that a generic roller mill is further developed so that the mill assembly is arranged in a container both for transport and for operation. Furthermore the swing lever units are respectively connected to the mill housing. Supports extend from the connection regions of the swing lever units to the bottom and/or carrying frame of the container. Vibration dampers are provided between the container bottom and/or the container carrying frame and the supports.

A core idea of the invention can be seen in the arrangement of a roller mill, in particular the mill assembly of the roller mill, in a container. However, the mill assembly is not only to be arranged for transport in this container but instead also during operation. This allows the mill assembly of the roller mill to be supplied in a container, to place the container with a purchaser of coal dust and to commence operation directly in the container.

The invention is further based upon the recognition that it is not possible to operate known mill assemblies in a container. It is hereby to be considered on the one hand that only a limited space is available within the container. On the other hand it is necessary to deviate from the conventional construction with fixed concreted bases for the mill, as this cannot be reconciled with operation within a container. Since, however, no bases for channelling off the forces arising during the grinding process are present these forces must be channelled off or collected in another way. For this purpose supports extend from the connection regions of the swing levers to the container bottom and/or container carrying frame. Vibration dampers are arranged between the container bottom or the container carrying frame and the supports. Vibrations which arise during the grinding process on the rollers or the swing levers thereof are hereby not transferred or only transferred to a very limited extent to the container itself.

Within the scope of the invention container carrying frames can be understood as the inner frame structure which carries the walls of the container.

In an advantageous embodiment the supports are connected in their upper region to the mill housing and in their lower region to the gear housing. A mill stand conventionally serves for partial receiving and carrying of the grinding pan. By means of the mill stand in generic roller mills the forces which act by means of the rollers via the grinding bed on the rotating grinding pan are channelled off into the base. In addition the mill stand carries the essential weight of the mill housing and also of a classifier possibly arranged above a grinding chamber. The weight of the grinding rollers and their swing lever units and also the forces which are absorbed by them are channelled off through separate mill stands into a further base which is mostly different from the base of the mill stand. The gear for the grinding pan can also be arranged in the mill stand.

As already stated, such a channelling off into bases cannot be realised or is difficult to realise during operation within a container. For this reason the supports which absorb the forces of the swing lever units with the grinding rollers are also connected to the gear housing. It is hereby possible on the one hand that the forces which act from the grinding rollers via the grinding bed on the grinding plate and from there on the gear housing can be compensated again with contrarily acting forces via the supports. It is further achieved that also vibrations which are normally emitted from the mill stand into the base—as the supports are arranged in a vibration damping way in relation to the container bottom and/or the container carrying frame—are not transferred or only transferred to a considerably reduced extent to the carrying frame of the container or the container itself.

In generic roller mills the grinding pan is driven in rotation. For this a mill gear is provided. In a further development of the invention the mill gear can be arranged below the grinding pan. An optional arrangement of the mill drive directly on the gear housing makes it easier to form the roller mill in such a way that it does not transfer vibrations and forces or transfers only very small vibrations and forces to the container.

It is further advantageous that the mill assembly is carried by the supports and that an interval is provided between the gear housing and the container bottom and/or the container carrying frame. A central thought here is that the complete mill assembly is carried by the supports, in particular exclusively by the supports. As described, the supports are mounted in a vibration damping way on the container bottom and/or the container carrying frame.

In order to allow hardly any or only very limited vibrations to be transferred to the container itself it is further provided that the gear housing is at a distance from the container bottom and/or the container carrying frame. Smaller vertical movements of the gear housing with the components of the roller mill fixed thereto are thus possible without there being contact between the gear housing and the container bottom and/or the container carrying frame.

In principle the mill housing itself can be formed as desired. It can for example be produced from sheet steel or similar. In case of a transportable roller mill it is advantageous if the mill hosing is cast. It is hereby possible to ensure in a simple and cost-effective way that standardised, virtually serially produced mill housings can be designed with the same construction as far as possible.

As the dimensions of a container are small in comparison with the dimensions of conventional coal preparation mills and thus only small roller mills can be provided in a container it is to be expected that in part a plurality of transportable roller mills are operated in parallel one beside the other by consumers of coal dust. As a result of the production of the dust directly at the location of the purchaser the tendency is to be expected that the number of transportable roller mills which are required on the market will increase. Through the use of cast components a small series production can thus be built up whereby on the one hand the production times and also the production costs are reduced.

A transportable roller mill can thereby be developed so that two grinding rollers arranged lying opposite form a grinding roller pair. If this grinding roller pair are hydraulically coupled to each other it can be ensured that fewer vibrations are transferred to the mill itself whereby on the one hand a smoother running of the mill is achieved, which brings about an increased throughput with lower energy costs. On the other hand this constitutes in turn an adaptation to the operation in a container as it is not possible with an operation in a container to channel off forces into a base in the bottom.

The hydraulic coupling can be designed for example by means of at least one hydraulic suspension cylinder which is respectively connected to arms which are respectively fixed to a shaft of the swing lever units. Such a construction can also be designed with limited space within a container if the hydraulic suspension cylinder extends directly between the respective arms. Due to the fact that the suspension cylinder is not arranged directly on the swing lever units but instead on arms which are fixed to the shaft of the swing lever units it is possible to provide the suspension cylinder outside of the actual grinding chamber or the inner housing so that it is on the one hand more easily accessible for maintenance purposes and on the other hand is not arranged in the inner space of the mill housing and must not therefore be specially sealed.

Two hydraulic suspension cylinders are preferably provided. Two arms can hereby be respectively arranged on a shaft of the swing lever units. A hydraulic suspension cylinder can respectively be provided between opposing arms. The arms can be fixed to the shafts so that the two hydraulic suspension cylinders are arranged on two different sides of the mill housing.

Besides the rotation speed of the grinding pans it is also possible to influence the throughput of a roller mill by varying the roller pressure. Roller pressure is understood for example to be the pressure with which the rollers press on the grinding bed of grinding material. The roller pressure can be set for example by means of the at least one hydraulic suspension cylinder for coupling the two grinding rollers. Corresponding devices can hereby be provided in a container for providing hydraulic liquid and for controlling the hydraulic suspension cylinder.

It is provided that at least one hydraulic suspension cylinder for pivoting out a grinding roller can be arranged directly or indirectly between an arm which is fixed to a shaft of a swing lever unit and one of the supports. By means of this hydraulic suspension cylinder the roller can be pivoted out of the mill housing as far as an intermediate position. The hydraulic suspension cylinder can hereby be controlled by external hydraulic control devices provided in the container. It is then possible for example to remove the grinding roller completely from the mill by means of a lifting tool provided in the container. By fixing the hydraulic suspension cylinder on a support, in comparison with fixing on the container itself or on a separate base, consideration is again given to the restricted space conditions in a container. In addition the vibration dampers of the supports are used in turn in order to transfer no vibrations or only limited vibrations to the container or the carrying frame thereof.

If the hydraulic suspension cylinder for pivoting out a grinding roller and the hydraulic suspension cylinder for suspending the roller pair have the same construction the suspension cylinder for pivoting out a grinding roller can be used as a replacement part. This is advantageous in particular as it is provided to use the transportable roller mill not only in greatly industrialised areas—such as Europe—in which an adequate infrastructure is present. The roller mill can also be used in emerging or developing countries in which the general infrastructure is often only basic.

The grinding components of a roller mill are usually used together with a classifier for classifying the ground material. It is thus advantageous if a classifier for the roller mill is provided in a further container and the classifier is designed so that it can be placed on the mill housing and fixed on it. The classifier can thereby be in operation for the large part in the further container. Due to the construction-based height of roller mills it is difficult to arrange them in a container. A second container is thus provided, in which the classifier is arranged. The container with the base or mill assembly of the roller mill and the further container with the classifier for the roller mill can thus be transported separately. When erecting the roller mill the container is placed with the classifier for the roller mill on the first container, in which the mill assembly of the roller mill is located. By means of closable openings in the container or container bottom the classifier can then be placed on the mill housing and fixed to it. Flange connections for example can hereby be used. In order to avoid having to remove the classifier during operation from the further container, the container and the classifier are designed so that the classifier in operation can for the large part remain in the further container.

As indicated, for operation of the roller mill, the classifier is placed on the mill housing. It can hereby project somewhat from its container. In order to ensure secure transport of the classifier, the classifier is arranged for a transport position in the further container in a raised position. The classifier is further secured by means of transport straps in the further container. The transport straps can be arranged between the classifier and the container.

It is to be considered in principle that transport means should be provided for displacement or movement of an assembly within a container as it is only possible with difficulty to use external cranes or forklift trucks for this. For the classifier for example a lifting tool can thus be provided on the upper carrying frame of the container so that the classifier can be drawn from the operating position, in which it is mounted on the mill housing, upwards into its container. To avoid that the classifier merely hangs on the lifting tool during the transport and possibly carries out a pendulum movement, securing straps are provided which can be fixed between the classifier and the container bottom or the carrying bottom thereof. A secure bearing of the classifier during transport is hereby facilitated, whereby the securing straps can easily be removed for operation of the classifier.

A further advantage of the use of transport straps is that these can be put in place again when the transportable roller mill is to be dismantled and constructed at another location and brought into operation.

The invention further relates to a transportable grinding installation for reducing solids, in particular solid fuels. The transportable grinding installation comprises at least one transportable roller mill with a mill assembly and a classifier, a hot gas generator, a dust filter, a dust dosing device and also solid storage devices, solid feed devices and solid preparation devices. Within the scope of the invention the term “transportable grinding installation” or “transportable roller mill” can be understood in that the grinding installation and the roller mill are light and easy to transport. The term “transportable” can also be regarded as mobile or non-stationary. It is essential in this connection that the grinding installation and the roller mill can be dismantled without great resources in comparison with conventional grinding installations and roller mills, transported to a new location and re-constructed and brought into operation there.

The grinding installation can be used to reduce solid fuels, for example coals such as brown coals or hard coals. In this connection the raw coal is introduced into the solid storage devices, for example by means of a front loader. The solid storage devices can be designed for example as raw coal bunkers which already facilitate a dosed output of the raw coal. Solid feed devices pass the raw material, for example the raw coal, from the solid storage devices to the roller mill. The solid feed devices can be designed as conveyor belts, vertical conveyors or for example also as screw conveyors. During the transport of the raw coal from the solid storage devices to the roller mill the raw coal can be pre-processed by solid preparation devices. For example the raw material can be fed to a breaker in order to thus reduce the feed size for the roller mill. It is also possible to provide metal detectors, magnetic separators and/or two-way separators in order to separate foreign substances from the raw material, for example the raw coal.

The raw material fed to the mill is ground in the mill and classified in a classifier. Grinding material which has a desired particle size is hereby conveyed further, other grinding material is passed back to the mill in order to be ground again there. The desired grinding material ground small is described in this application as dust.

The dust can be fed via an air flow to a dust filter, in which the dust is separated. The separated dust is subsequently fed to a dust dosing device.

In order to also dry the raw material, for example the raw coal, during the grinding process the hot gas generator is provided which can also be operated with a part of the dust produced. It produces a hot process gas which can be used in the mill for drying and for further technical processes. The dust is then fed from the dust dosing device to the purchaser, for example directly by means of pipelines. The purchaser can use the dust for example in asphalt mixing plants for the production of road surfacing, for a steam generator for operation of a steam turbine for current generation, for a hot gas generator for production of hot gases or for general drying purposes.

In order to improve the mobility or the transport properties of the grinding installation and also to further improve a rapid erection and operation it is provided that the dust filter and the dust dosing device are arranged for transport and for operation in one or more containers and that at least a large part of the solid storage devices, the solid feed devices and the solid preparation device are arranged for operation in one or more other containers. In particular the solid feed devices can be provided between the individual containers in order to transport the solid material from one device of the grinding installation to another.

In a similar way pipelines for process gases with or without dust can extend between the individual containers. By providing as many assemblies of the transportable grinding installation as possible in containers, which can remain therein both for transport and for operation an increased mobility of the grinding installation is achieved. A simple transport of the grinding installation in individual containers is thereby possible. As the individual assemblies also remain in the containers during the operation merely an erection of the containers and connection of the assemblies across the containers is necessary so that the operation can be carried out relatively quickly. Due to the fact that the individual assemblies remain within the container a dismantling of the installation is possible relatively swiftly so that it can then in turn be quickly and easily transported away in the containers and be re-constructed at a new place of use.

It is preferable if the containers used are designed as ISO containers of twenty and/or forty feet. The containers can thereby have a standard height or be designed as high cube containers. ISO containers constitute a logistics standard. It is hereby ensured that transport of the transportable grinding installation is possible in a simplified manner as standard holders for supports and fixtures for these containers are already available and do not have to be specially brought to the location.

It is provided that the containers comprise closable openings for passing through solid feed devices, grinding material transport lines, process gas lines and/or for parts of the grinding installation. The provision of defined closable openings on the containers offers the advantage that the containers are closed so as to be essentially weatherproof during the transport so that the assemblies and parts stored therein can be transported with protection. After the erection or during erection of the containers for the transportable grinding installation the openings are opened so that components or grinding material transport lines can be passed through the openings and thus the flow of the ground raw material as well as already ground raw material is facilitated between the containers to the individual assemblies. As already explained in connection with the classifier and the grinding assembly it is also possible to provide individual assemblies which extend across a plurality of containers.

In principle the individual assemblies or components of the transportable grinding installation can be arranged in any suitable containers. It has proved advantageous if the grinding assembly and the heat generator are arranged in a first 40 feet container in operation and parts of the classifier as well as electrical and hydraulic operating devices for the transportable grinding installation in a second 40 feet container also in operation. Furthermore the raw material bunker can be designed as a first 20 feet high cube container and the dust filter can be arranged in operation in a second 20 feet high cube container. During operation a raw material breaker and further solid feed devices can be arranged in a first 20 feet container and at least parts of the dust dosing device in a second 20 feet container.

The division into the containers described is useful as direct connections must exist between individual assemblies such as for example between the mill assembly and the hot gas generator. It is advantageous to arrange these connections within a container. On the other hand it is advantageous to arrange assemblies which produce a lot of dirt such as the breaker or the raw material bunker in their own container so that the other components are not unnecessarily contaminated and impaired. It is also to be considered in the division into the individual containers whether the assembly fits into a container of the corresponding dimensions or not. It is hereby preferred for example that the high cube container, in which the dust filter is provided, is used upwardly in operation in order to be able to also place the dust filter therein during operation.

If the mill assembly and the hot gas generator are arranged in the same container the path of the hot gas is very short. In dependence upon the hot gas generator used this can lead to an uneven temperature profile with hot gas traces at the mill entry. It is therefore advantageous to provide dam plates in the path of the hot gas between the roller mill and the hot gas generator which lead to evening out of the temperature profile. Alternatively or additionally one or more flow intersections can also be provided in order to destroy angular momentum in the hot gas.

During operation of the grinding installation the container with the classifier is located on the container with the mill assembly. The hydraulic station for the roller mill can also be found in the classifier container. The storage elements for hydraulic pressure or the hydraulic liquid itself can, however, be housed in the mill container. In order to connect the hydraulic station separably with the storage elements lines are used with rapid coupling. For the lines between hydraulic cabinet and suspension cylinders ball cocks can be used which can optionally be electrically controlled.

Through the arrangement of the individual assemblies of the inventive grinding installation in standardised containers the installation design can also be standardised. This hereby results in the advantages of a small series production such as lower production costs through higher rates. Due to the fact that each installation has essentially the same structure a relatively short delivery period of for example less than six months can be achieved. Through the same structure of the inventive grinding installation the assembly and the operation can take place for example in 2 to 3 weeks. This is also possible as depending upon construction no base is necessary for the roller mill. Due to the provision of the essential assemblies in containers the installation can be dismantled in approximately three weeks and re-constructed at another location. A complete works trial run before delivery can be realised with the inventive grinding installation.

The invention is explained in greater detail below by reference to example embodiments and schematic drawings, in which:

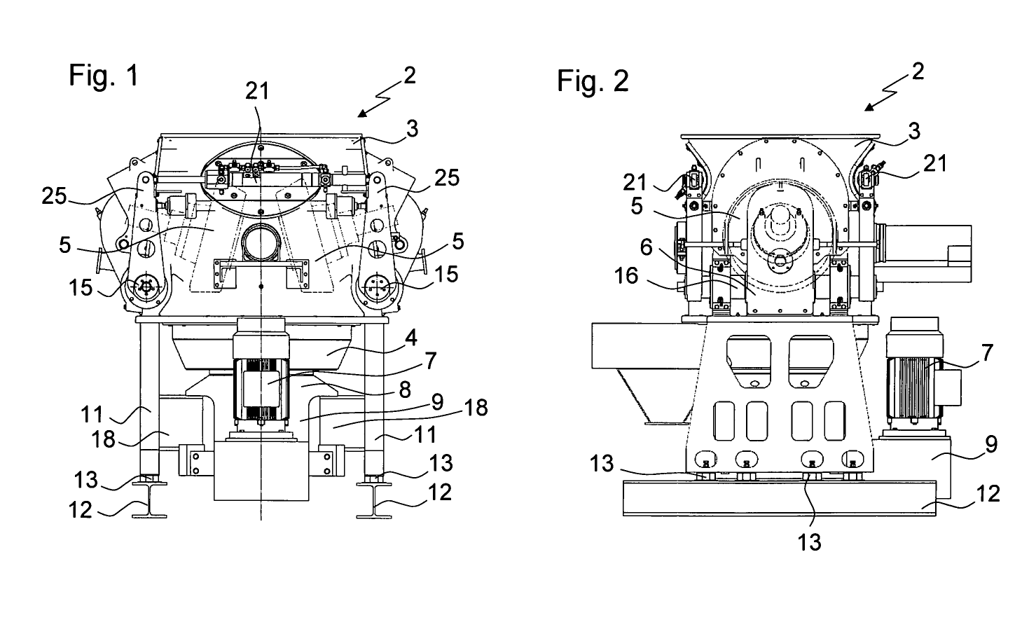

FIG. 1 shows a side view of a mill assembly of an inventive roller mill with grinding rollers indicated;

FIG. 2 a side view of a mill assembly of an inventive roller mill according to FIG. 1 with grinding rollers indicated, rotated by 90°;

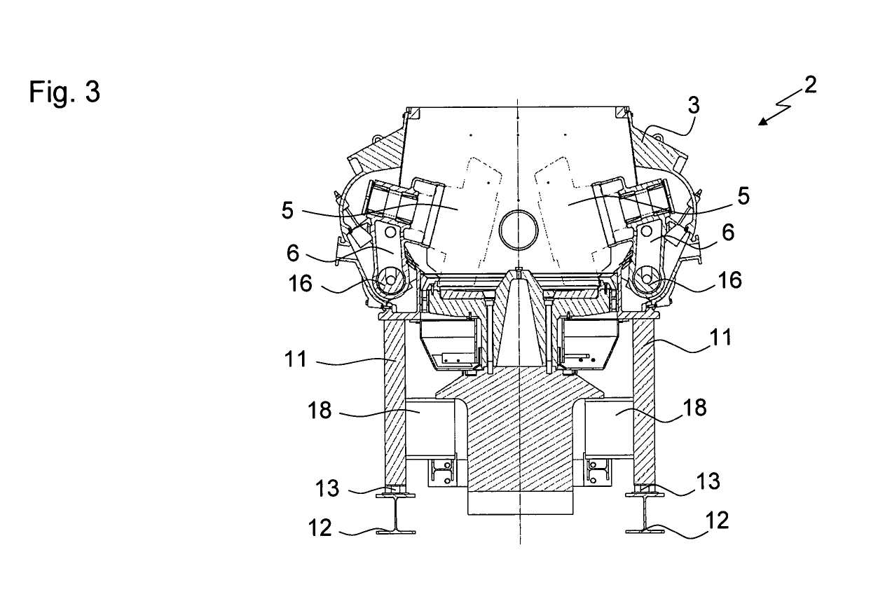

FIG. 3 a vertical section through a mill assembly of an inventive roller mill, extensively according to FIG. 1;

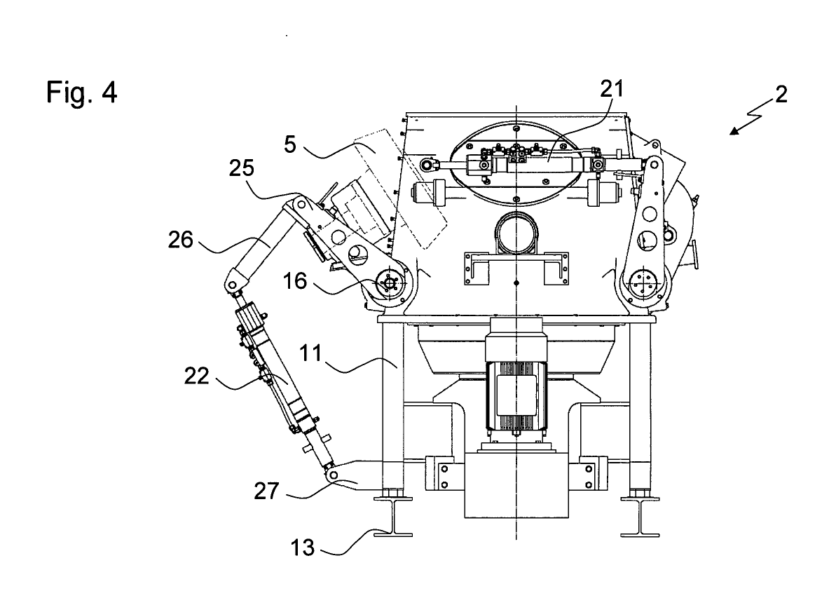

FIG. 4 a side view of a mill assembly of an inventive roller mill with a partially pivoted out grinding roller;

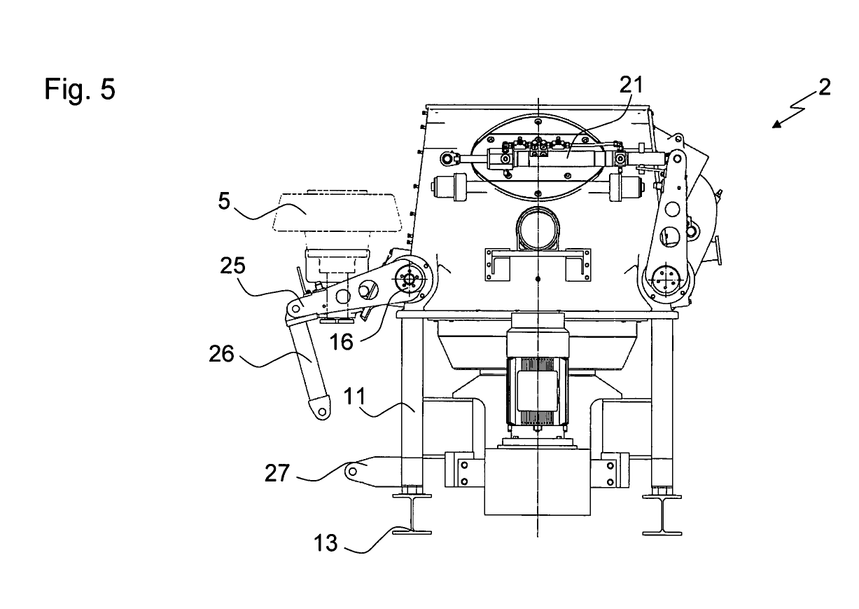

FIG. 5 a side view of a mill assembly of an inventive roller mill with pivoted out grinding roller;

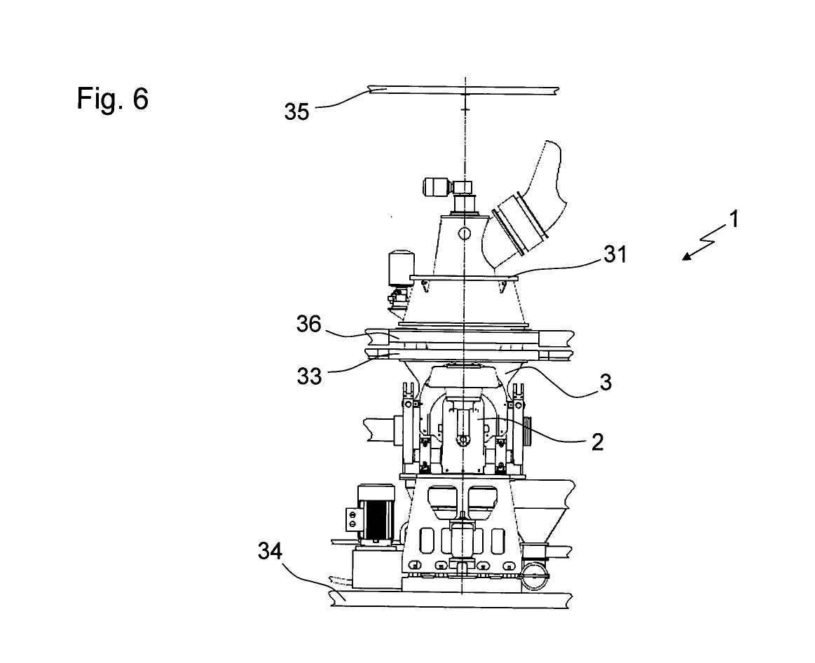

FIG. 6 an inventive roller mill with mill assembly and incorporated classifier;

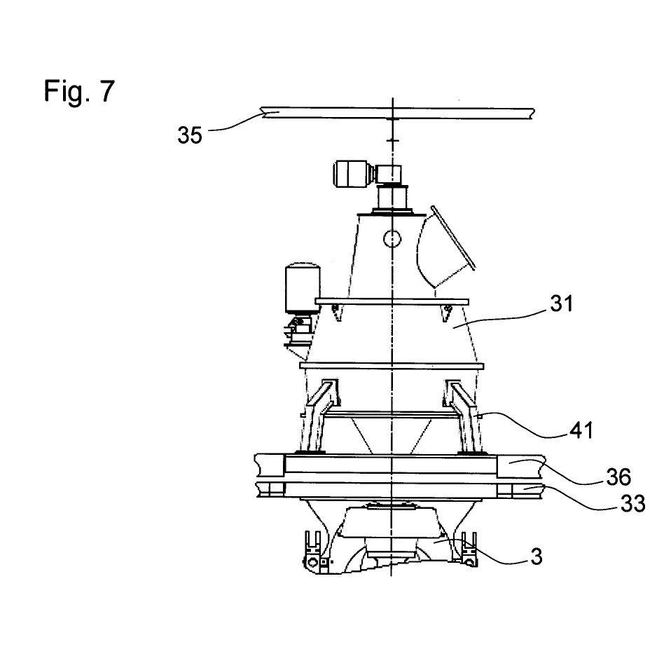

FIG. 7 a classifier of an inventive roller mill in the transport state;

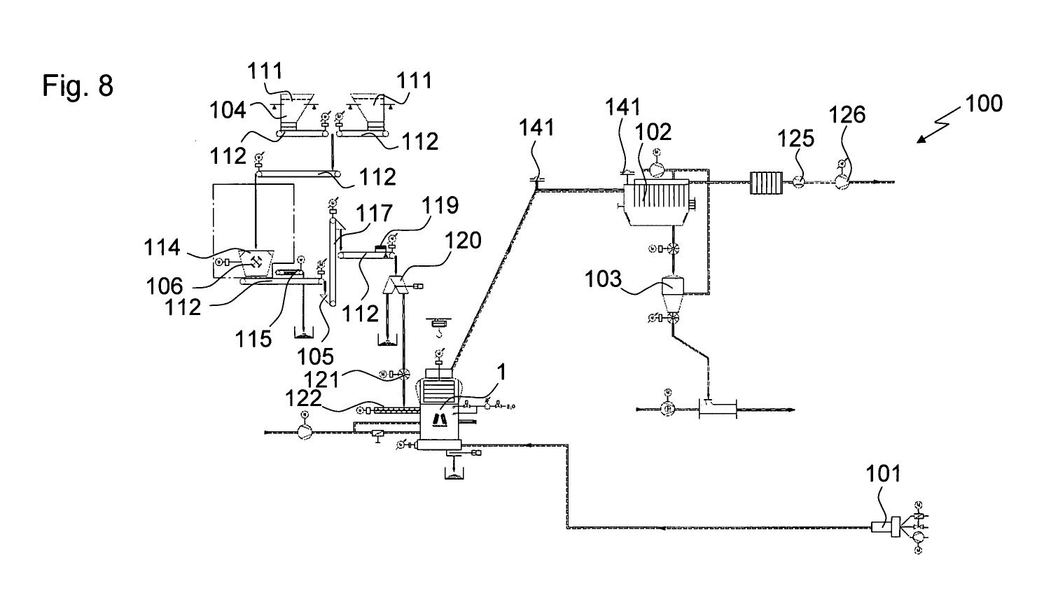

FIG. 8 a process flowchart of an inventive grinding installation for air-swept operation;

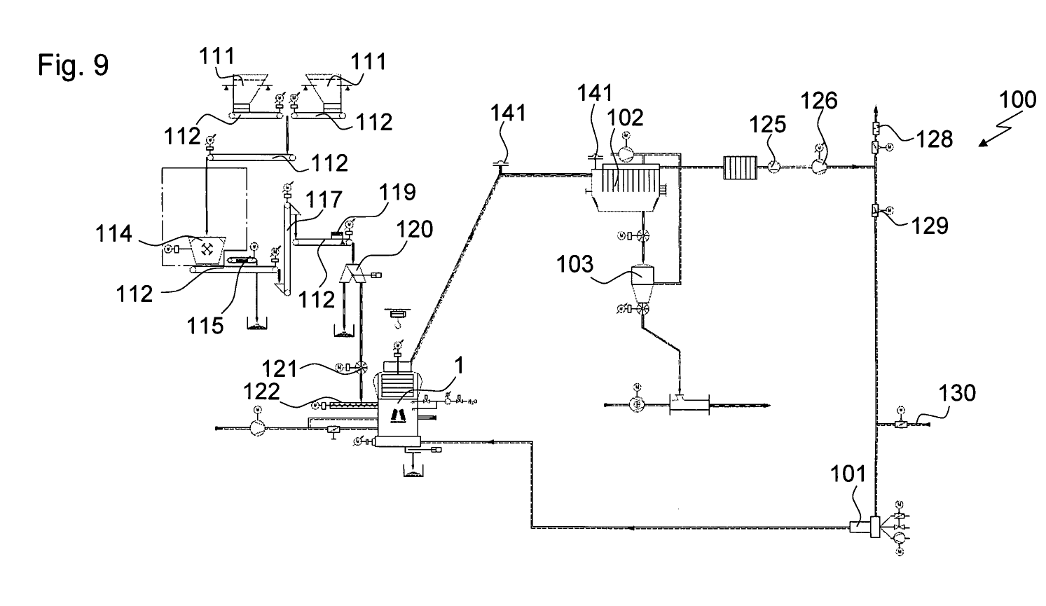

FIG. 9 a process flowchart of an inventive grinding installation for self-inert operation; and

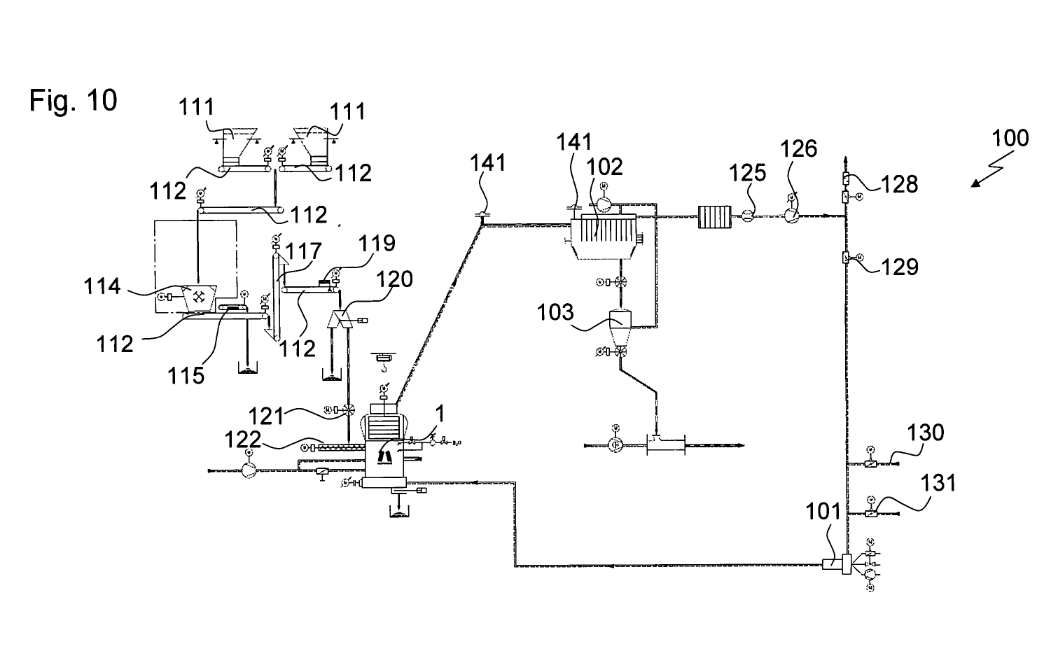

FIG. 10 a process flowchart of an inventive grinding installation for an external inertia operation.

FIGS. 1 and 2 show a mill assembly 2 of an inventive roller mill 1 in two different side views. The grinding rollers 5 are hereby indicated by the dotted lines.

The mill assembly 2 comprises a mill housing 3 and a gear housing 9. The indicated grinding rollers 5 and a grinding pan 4 (not shown) are located in the mill housing 3. The grinding rollers 5 are held by swing lever units 6. The swing lever units 6 comprise in turn a shaft 16 which is rotationally mounted on the mill housing 3. It is hereby possible to pivot the grinding rollers 5. The grinding chamber is downwardly closed by the grinding pan 4 (not indicated) which is also described as a grinding plate. A grinding bed of material to be ground is formed on the grinding pan 4, on which the grinding rollers 5 roll. The grinding pan 4 is thereby driven in rotation.

A grinding pan drive 7 is provided for the grinding pan 4 which can for example be designed as an electric motor or gear motor. The grinding pan 4 is rotationally mounted on the gear housing 9 so that it can be displaced in rotation via a gear 8. In contrast to conventional roller mills with larger dimensions the swing lever units 6 are mounted rotationally on the mill housing 4 via the shaft 16. With large conventional roller mills for coal grinding separate swing lever stands are provided.

Supports 11 extend downwardly from the connection regions 15 of the swing lever units 6, in particular from the shafts 16 thereof, which supports 11 are also described as carrying supports. At the lowermost end of the supports 11 there are vibration dampers 13. The supports 11 are located via these vibration dampers on the container carrying frame 12. A mill stand is conventionally located on the bottom so that it can deflect the weight of a roller mill essentially onto its base. Since, however, the inventive roller mill 1 is arranged in a container it is not possible to channel off the forces produced into a base. In addition even with optimal adjustment of the roller mill, in particular of the grinding roller pressure, the grinding pan speed and the grinding bed, vibrations arise in the roller mill 1. As other assemblies are also located in the container in which the mill assembly 2 of the roller mill 1 is arranged and also containers can be arranged on the container with the mill assembly 2 of the roller mill, setting in vibration of the containers should be avoided. The roller mill 1 is thus designed so that its full weight is carried via the supports 11 which form the only contact points via the vibration dampers 13 with the container or the carrying frame 12 thereof. For this reason the gear housing 9 is also hung or fixed by means of transverse supports 18 to the supports 11.

This results in a further advantage that the forces acting during grinding through the grinding rollers 5 via the grinding bed on the grinding pan 4 can be passed back via the gear 8 existing with the grinding pan 4 or respectively the gear housing 9 to the supports 11. The swing levers of the swing lever units 6 are connected to the shaft 16. Sticking is possible for example in order to thus be able to transfer the required torques without a notch effect. The connecting point can be designed as a combination of press fit and adhesion.

FIG. 3 shows a section through the mill assembly 2 of the inventive roller mill 1. The grinding rollers 5 are hereby indicated again. The grinding rollers 5 are rotationally mounted in the respective swing lever units 6. The swing lever units 6 in turn comprise a shaft 16. The swing lever units 6 can be pivoted about this shaft 16.

The advantageous stand structure of the mill assembly 2 of the inventive roller mill 1 is explained below. The supports 11 comprise cross supports 18. The gear housing 9 is fixed in turn to the lateral cross supports 18, in which gear housing 9 the mill gear 8 is integrated. The weight of the gear housing 9 is thus passed via the cross supports 18 to the supports 11. The grinding pan 4 is provided on the gear 8.

The supports 11 are fixed to the housing 3 of the roller mill assembly 2. The axis 16 of the swing lever units 6 is essentially in a conceived extension of the supports 11.

An interval or an air gap is provided between the lower edge of the gear housing 9 and the bottom of the container or the carrying frame 12 of the container. The only contact between the roller mill 1 or the mill assembly 2 thereof and the container is thus via the vibration dampers 13. These serve in operation of the roller mill 1 to transfer as few as possible or no vibrations to the container itself. In this connection the vibration dampers 13 are preferably designed so that they facilitate good damping in the vibration resonance region of the mill.

Different transport securing elements can be provided for transport for the mill assembly 2. It is hereby possible for example to deactivate the vibration dampers 13 in that additional angular elements, blocks or plates produce a fixed connection between the supports and the container bottom or the carriers of the container. It can also be provided that the grinding plate and/or the grinding rollers 5 are secured. The grinding rollers 5 can thus be drawn together for transport with tension straps or with threaded rods. These can then be pressed against stop buffers or onto the grinding plate.

FIG. 4 shows a side view of the mill assembly 2 of the inventive roller mill 1 with partially pivoted out grinding roller 5. FIG. 5 shows in turn a side view of the mill assembly 2, in which the grinding roller 5 is further pivoted out.

The two opposing rollers 5 form a coupled grinding roller pair. The coupling is facilitated by two hydraulic suspension cylinders 21. Arms 25 are respectively provided on the shafts 16 of the swing lever units 6. These are arranged on both sides of the swing lever units 6. A hydraulic suspension cylinder 21 is arranged respectively between two opposing arms 25. Through the coupling of the two grinding rollers 5 smooth running of the roller mill 1 can be achieved, which is necessary particularly during operation within the container.

In addition the rolling pressure exerted by the grinding rollers 5 on the grinding bed can also be determined by means of the hydraulic suspension cylinders 21. For this purpose the pressure of the suspension cylinders 21 can be controlled via a hydraulic control unit.

By means of a suspension cylinder 22 a pivoting out process for a grinding roller 5 can be realised, for example in order to exchange it. In this connection a second arm 26 can be arranged on the arm 25. The second suspension cylinder 22 extends from the second arm 26, which second suspension cylinder 22 is also hydraulically designed, to a releasable fixing 27 in the lower region of a support 11. It is hereby advantageous if the suspension cylinder 22 is fixed above the vibration dampers to the roller mill 1 again as otherwise undesired vibrations can be transferred to the container. In order to pivot out a roller firstly the suspension cylinders 21 are released from their fixture on the arm 25. They can then be placed in holders provided for this purpose on the mill housing 3. Using the suspension cylinder 22 the arm 25 and thus the swing lever unit 6 can be pivoted backwards to an intermediate position. If the grinding roller 5 is pivoted out to the intermediate position it can be hung for example in a chain hoist of a lifting tool which is provided in the ceiling region or on the ceiling carriers of the container. The suspension cylinder 22 can then be removed so that the grinding roller 5 can be pivoted completely outwards, as shown in FIG. 5. The grinding roller 5 can now be removed with the aid of the lifting tool from its holder and a new grinding roller 5 incorporated.

The suspension cylinders 21 and the suspension cylinder 22 can be designed with the same construction, whereby provision of replacement parts is simplified. The suspension cylinder 22 can also be used as a replacement cylinder for the suspension cylinders 21. As the suspension cylinder 22 is only used and assembled for the pivoting out process of the rollers it can normally be mounted for example in a hydraulic cabinet. If one of the suspension cylinders 21 has a malfunction it is possible to use the suspension cylinder 22 not used in normal operation as a replacement for the defective suspension cylinder 21.

FIG. 6 shows the inventive roller mill 1 in the operating state. A classifier 31 is hereby arranged on the mill assembly 2 and fixed to it or to the mill housing 3. As set out above, the mill assembly 2 is located in its own container. A ceiling region 33 and a bottom region 34 of this container are shown. The classifier 31 in turn is provided in a further container, of which likewise a ceiling region 35 and a bottom region 36 are shown. In order to secure the classifier 31 on the mill assembly 2 there are closable openings in the bottom region 36 and in the ceiling region 33 of the respective containers. The classifier 31 can hereby be placed on the mil housing and fixed thereto. This can take place for example through flange-like screws or shape locking and/or force locking fixtures.

At least a part of the classifier 31 projects in the operating state out of the container of the classifier into the container of the mill assembly. No transport is possible in this state.

FIG. 7 shows the transport position of the classifier 31. In order to convey the classifier 31 from the operating position shown in FIG. 6 into the transport position the classifier is raised. This can take place for example via a lifting device fixed to the ceiling 35 of the classifier container such as a lifting tool or similar. If the classifier 31 is raised transport straps 41 are arranged between the classifier 31 and the bottom of the container or its carrying structure which stabilise the classifier and at least partially also carry a weight. The classifier container which is on the container with the mill assembly can then be raised from it. In this connection the openings are closed in the ceiling 33 of the container with the mill assembly and in the bottom 36 of the container with the classifier 31 so that the assemblies located in the containers are protected during transport. In order to secure the classifier rotor which is not shown during transport the rotor can be supported and secured by an auxiliary construction incorporated from below into the raised classifier 31.

FIGS. 8 to 10 show different operating modes of an inventive grinding installation.

FIG. 8 shows a process flowchart for operation of an inventive grinding installation 100 in air-swept operation. The operating mode and the individual assemblies are described in more detail below.

In the embodiment shown here coal is ground as a solid fuel. Two raw coal bunkers 111 are used as a solid storage device 104. Purchased or required raw coal is fed into these bunkers 111 by means of a front loader. The raw coal should hereby have a maximum particle size of 250 mm. The solid storage device 104 can also be designed as a feed bunker. This can comprise two feed units with two discharge belts and a hydraulically activated oversized particle sieve and be formed as a 20 feet high cube container. On the upper side of the container filling funnels can be folded out after transport. The raw coal is then conveyed via solid conveying devices 105 in the form of conveyor belts 112 to a breaker 114. This breaker 114 is an example for a solid preparation device 106. The raw coal is broken down in the breaker 114 for example to a maximum particle size of approximately 30 mm. The raw coal is then fed to the inventive roller mill 1 via further conveyor belts 112. The broken raw coal is examined on the conveyor belts 112 for foreign material, in particular metal. This can be carried out for example by means of a magnetic separator 115 or in interplay with a metal detector 119 and a two-way separator 120. In order to overcome height differences which arise through the supply of the broken raw coal a vertical conveyor 117 can also be used.

The broken raw coal is conveyed after the filtering out of the metal into the feed of the roller mill 1. This takes place for example via a rotary feeder 121 and an inlet screw conveyor 122. The raw coal is ground to a fineness of 5% to 45% R to 90 μm and dried in the roller mill.

We shall forego a detailed description of the grinding and drying process in the roller mill 1 which is also described as an air-swept mill or vertical mill. The coal dust passes, once it has been classified in the classifier 31 of the roller mill 1, into a dust filter 102.

The coal dust is separated there. The dust filter 102 can comprise a rotary feeder. The dust passes from the dust filter 102 into a dust dosing device 103, from which it can be fed to the consumer. An intermediate bunker can be provided between the dust filter 102 and the dust dosing device 103. The intermediate bunker can, however, also be integrated in the dust dosing device 103. The dust dosing device 13 is advantageously formed to supply a plurality of consumers from a dosing device.

During operation of the grinding plant 100 hot process gas is generated by means of the hot gas generator 101 which is fed to the roller mill 1 for operation and drying of the broken raw coal. The hot gas generator itself can be operated by means of liquid fuel but also by means of the coal dust generated. When using a dust dosing device 103 which is designed to supply a plurality of consumers from a dosing device it is possible, besides different consumers, for the hot gas generator 101 to be supplied with coal dust.

The roller mill 1 itself and the lines for the dust to the dust filter 102 are in an ATEX zone 20. For this reason this region should be designed to be either pressure resistant or pressure surge resistant. In this connection for example two pressure relief devices 141 are provided. The pressure relief devices 141 are designed so that they preferably discharge vertically upwards. The forces produced can thus be better channelled off into the container structure and into the bottom. In addition there is hereby a lower risk of tipping. This further offers the advantage that during positioning of the grinding installation 100 less attention needs to be paid to outlet jets in case of explosion and there is thus greater freedom for positioning.

FIG. 9 shows a further embodiment of the inventive grinding installation 100 which is designed for self-inert operation. The storage and feed of the raw coal or the broken raw coal to the roller mill 1 is realised in the same way as already described by reference to FIG. 8.

The installation of FIG. 9 differs essentially from the installation according to FIG. 8 in that after the volume flow measurement 125 and the process fan 126 a flue with valves 128 is provided. In addition a return gas line is provided, in which a return gas valve 129 and a fresh air feed 130 are provided.

The self-inert operating mode of the grinding installation 100 differs from the air-swept operation of FIG. 8 in that firstly within the mill and the feed and discharge lines connected to it an inert atmosphere is built up which is self-maintaining in operation.

For the initial inertisation of the installation different processes are possible which can also be used in combination with each other. For example during start-up of the installation firstly a mill ventilator is started in the region of the roller mill 1. Subsequently the hot gas generator 101 is started. After reaching a certain temperature of the hot gas water is injected into the hot gas channel before the roller mill 1 and evaporated. Water vapour is an inert gas. During the start-up the roller mill installation 100 is operated with as much return gas as possible but without exceeding the dew point. Return gas means that as much gas as possible is fed back to the hot gas generator 110 via the return gas channel with the return gas valve 129. This process is continued until an inert atmosphere has built up in the circuit. Subsequently the feeding of coal into the roller mill 1 is commenced.

It is hereby to be considered that during the start-up process for a limited time in case of a higher oxygen content an explodable atmosphere can be produced if dust not transported to the dust filter 102 beforehand is swirled up. The zone from the roller mill 1 to the dust filter 102 is thereby to be regarded as an ATEX zone 21. For this reason corresponding constructive pressure reliefs are provided in this endangered zone, as already described in relation to the air-swept operation. The installation can for example be designed in a pressure surge resistant way for a pressure of 3.5 bar.

Another possibility for initial inertisation of the circuit is to use foreign flue gases for this purpose. If the transportable grinding installation 100 is used for example in areas in which sufficient infrastructure is not available an external power supply is necessary. This can be realised for example through a diesel unit. The waste gases of the diesel generator can be incorporated into the mill circuit as inertisation gases or flue gases for initial inertisation.

As soon as the grinding installation 100 has been inertised the feeding of the coal can—as described—be commenced. In order to maintain the inert state of the grinding installation 100 the moisture can be partly or even completely (in dependence upon the coal moisture) taken from the supplied coal. The oxygen content is measured continuously after the dust filter 102 and before the roller mill 1 and can be adjusted through additional water injection. A self-inert operation of the installation is hereby facilitated.

In principle this installation is also suited for air operation with recirculation.

FIG. 10 shows an extension of the grinding installation 100 for inert operation. In this case the installation is suited to also be operated in external inert operation. For this purpose an external flue gas supply 131 is provided in the gas recirculation branch of the mill circuit. By means of this feed inert flue gases can be fed which arise for example during vapour generation or asphalt production.

The operation of the grinding installation 100 is hereby similar to that already described having regard to FIG. 9. In principle it is also possible to carry out the initial inertisation, which was described having regard to FIG. 9 as an example of use of the flue gases of a diesel generator, through the further inert external flue gases.

In general the inventive grinding installation 100 should be operated with an oxygen content of maximum 10%. In order to ensure this O₂ and/or CO measuring devices can be provided at different points, for example before the roller mill 1 and/or after the dust filter 102. It is hereby decided using the oxygen content determined whether the installation can continue to be safely operated. In case of an oxygen content of 11% an alarm must be emitted and the installation switched off upon exceeding an oxygen content of 12%. In contrast, the evaluation of CO measurements is used to check whether during a standstill of the installation flue gases develop, for example through a fire or similar.

In this connection it can also be provided for safety reasons to provide N₂ or CO₂ batteries or tanks, by means of which in case of determination of an oxygen content which is too high the mill circuit can be flooded with inert gases so that the oxygen content is lowered and a potential explosion is thus prevented.

When using the produced coal dust as a fuel for the hot gas generator it is further to be considered that the ash produced cannot be baked or sintered. During operation of a hot gas generator with gas or oil said hot gas generator is operated with a λ of 1.2 to 1.3. The λ value hereby constitutes the relationship of air to fuel in comparison with a stoichiometric mixture. In case of the aforementioned λ value of 1.2 to 1.3 there is a residual oxygen content of approximately 2.5 in the flue gas. This is not problematic for the operation of the roller mill installation 100.

When using carbon as a fuel, however, the burner must be operated at a λ of 1.6 to 1.8. The high air excess is necessary for the reduction of the flame temperature in order that this lies below the ash softening point and baking of the ash is thus prevented. However, during operation of a hot gas generator with such a high λ value a residual oxygen of approximately 7.5% is produced in the flue gas. The self-inert operation of the grinding installation 100 is hereby endangered. For this reason a water injection can be provided in order to generate additional inert gases. Another possibility is to achieve the required high λ values by feeding in external inert process gases in the hot gas generator. A further possibility for lowering the O₂ content in the flue gas after the hot gas generator can be achieved with the aforementioned construction-related high λ values in that the combustion air of the burner is mixed with corresponding portions of return gas.

A grinding installation described here is dimensioned so that it delivers a throughput of approximately 2 to 4 t coal dust per hour. When using hard coal with a calorific value of approximately 30 MJ/kg dust as fuel for a thermal power of 34 MW with a production of 4 t dust per hour results. Accordingly when using brown coal with a calorific value of approximately 20 MJ/kg dust as fuel for a thermal power of approximately 22 MW is produced.

The inventive roller mill and the inventive grinding installation are accordingly simple and efficient to transport and require only a very short time to bring into operation.

1-15. (canceled)

16. Transportable roller mill for reducing solids, in particular solid fuels, with a mill assembly, which comprises
a mill housing,
a grinding pan,
at least two grinding rollers which roll on the grinding pan,
wherein the grinding pan and the at least two grinding rollers are arranged in the mill housing,
at least two swing lever units whereby a grinding roller is mounted on each swing lever unit,
a grinding pan drive,
a gear for the grinding pan and
a gear housing,
characterised in that
the mill assembly is arranged for transport and operation in a container,
the swing lever units are respectively connected to the mill housing,
supports are provided from the connection regions of the swing lever unit to the bottom and/or to the carrying frame of the container, and
vibration dampers are arranged between the bottom and/or the carrying frame of the container and the supports.

17. Transportable roller mill according to claim 1, characterised in that
the supports are connected in their upper region to the mill housing, and
the supports are connected in their lower region to the gear housing.

18. Transportable roller mill according to claim 1,
characterised in that
the gear housing is arranged at least partially below the grinding pan.

19. Transportable roller mill according to claim 1,
characterised in that
the mill assembly is carried by the supports and
an interval is provided between the gear housing and the bottom and/or the carrying frame of the container.

20. Transportable roller mill according to claim 1,
characterised in that
the mill housing is cast.

21. Transportable roller mill according to claim 1,
characterised in that
two opposing grinding rollers form a roller pair and
the roller pair are hydraulically coupled to each other,
wherein the hydraulic coupling is carried out by means of at least one hydraulic suspension cylinder which is respectively connected to arms which are respectively fixed to a shaft of the swing lever units.

22. Transportable roller mill according to claim 1,
characterised in that
at least one hydraulic suspension cylinder for pivoting out a grinding roller can be arranged directly or indirectly between an arm which is fixed to a shaft of a swing lever unit and a support.

23. Transportable roller mill according to claim 5,
characterised in that
the hydraulic suspension cylinder is designed to pivot out a grinding roller and the hydraulic suspension cylinder is designed to couple the roller pair with the same construction.

24. Transportable roller mill according to claim 1,
characterised in that
a classifier for the roller mill is provided in a further container,
the classifier can be placed on the mill housing and is designed so that it can be fixed to it, and
the classifier is located in operation mostly in the further container.

25. Transportable roller mill according to claim 9,
characterised in that
the classifier can be arranged for a transport position in the further container in a raised position and
the classifier can be secured by means of transport straps in the further container which can be arranged between the classifier and container bottom.

26. Transportable grinding installation for reducing solids, in particular solid fuels,
characterised by
a transportable roller mill according to claim 9,
with a hot gas generator,
with a dust filter,
with a dust dosing device,
with solid storage devices,
with solid feed devices and
with solid preparation devices.

27. Transportable grinding installation according to claim 11,
characterised in that
the dust filter and the dust dosing device are arranged for transport and operation in one or more containers and
at least the majority of the solid storage devices, the solid feed devices and the solid preparation devices are arranged for operation in one or more containers.

28. Transportable grinding installation according to claim 11,
characterised in that
the containers are designed as ISO containers of 20 or 40 feet with standard height or as high cube containers.

29. Transportable grinding installation according to claim 11,
characterised in that
the containers comprise closable openings for passing through solid feed devices, grinding material transport lines, process gas lines and/or parts of the grinding installation.

30. Transportable grinding installation according to claim 11, characterised in that
in operation the mill assembly of the transportable roller mill and the hot gas generator are arranged in a first 40 feet container,
in operation parts of the classifier and electrical operating devices are arranged in a second 40 feet container,
a raw material bunker is designed as a first 20 feet high cube container,
in operation a raw material breaker and solid feed devices are arranged in a first 20 feet container,
in operation the dust filter is arranged in a second 20 feet high cube container and
in operation at least parts of the dust dosing device are arranged in a second 20 feet container.
